(19) United States
(12) Patent Application Publication
(10) Pub. No.: US 2004/0068559 A1
(43) Pub. Date: Apr. 8, 2004

(54) Method for detection of unauthorized computer system usage

(76) Inventor: Terry D. Shaw, Broomfield, CO (US)

Correspondence Address: PATTON BOGGS, PO BOX 270930, LOUISVILLE, CO, 80027, US

(21) Appl. No.: 10/264,878

(22) Filed: Oct. 4, 2002

(51) Int. Cl. G06F 15/173

(52) U.S. Cl. 709/224; 713/200

(57) ABSTRACT

The method for detecting unauthorized computer system usage monitors the subscriber's activities while using the computer system, the system activities and the Internet activities. When the computer system is initialized, the subscriber may manually or automatically set parameters for determining when an activity is unauthorized. When an activity is detected with deviates from normal system usage and operation, the activity is unauthorized. The unauthorized activity may be recorded in an activity log, may be terminated by the computer system, or the subscriber may be notified of the unauthorized usage.

### FIELD OF THE INVENTION

The invention relates generally to computer equipment security, and more specifically to a method for detecting autonomous usage of a computer system connected to the Internet.

### PROBLEM

It is a problem in the field of computer systems to prevent unauthorized and/or autonomous collection of information regarding computer system usage and unauthorized dissemination of the collected information. Executable applications on the Internet may be autonomously downloaded to a subscriber's equipment connected to the Internet for autonomous usage in the background during operation of the equipment by the subscriber while the equipment is connected to the Internet. The Internet subscriber is often unaware of the installation on the equipment, the usage of the application to collect stored data, and the ability of the application to transmit the stored data via the equipment Internet connection to an unauthorized third party.

The autonomous applications may include peer-to-peer applications such as file sharing techniques, which once loaded by the subscriber must be consciously disabled or uninstalled by the subscriber to prevent autonomous use. The autonomous application may also use a distributed computing technique wherein the subscribers CPU and storage media is autonomously used with the resulting data being transmitted via the Internet connection to a central computer. Autonomous usage of a large number of computer CPUs speeds the processing and reduces the equipment required at the central computer. Another application which may be autonomously executed on a subscriber's equipment may collect information on the subscriber's personal use and forward the collected information to an entity such as an advertiser.

A first problem is that autonomous execution of applications uses the subscribers CPU processing capacity and storage media capacity without the subscriber's knowledge and often without the user's permission. A second problem arises when the autonomous use includes Internet usage for transferring information. The autonomous execution of these applications may result in substantial consumption of bandwidth by the subscriber. If the broadband high-speed service provider has a tiered billing system based on bandwidth consumption used by the subscriber, the autonomous use may lead to excessive service charges.

A known solution to the problem is firewall software to prevent the unauthorized download of the executable application to the subscriber's equipment. However, firewalls are vulnerable. Many peer-to-peer applications are designed to enable data to be passed through a firewall. Another problem with the usage of firewalls to prevent unauthorized downloading and later autonomous use of the subscriber's equipment is the inability of firewalls to correlate the subscriber's physical interaction with the Internet, the equipment central processing unit (CPU), and usage of the equipment storage media to guard against this vulnerability. Likewise, system-monitoring tools that may monitor such activities do not provide tools to notify the user of the unauthorized or autonomous activity or to prevent and/or terminate the unauthorized usage based on the observed equipment operation and subscriber physical interaction with the equipment.

For these reasons, a need exists for an unauthorized equipment usage detection application which detects the unauthorized download and/or autonomous usage and performs the steps necessary to prevent and/or terminate the unauthorized and/or autonomous usage.

### SOLUTION

The present method for detecting unauthorized computer system usage monitors the subscriber's activities while using the computer system, the system activities and the Internet activities. When an activity is detected with deviates from normal system usage and operation, the activity is unauthorized. The unauthorized activity may be recorded in an activity log or may be terminated by the computer system.

When the computer system is initialized, the subscriber may manually or automatically set parameters for determining when an activity is unauthorized. When manual initialization is selected, the subscriber sets parameters such as monitoring time interval, normal subscriber activities, and Internet upstream and downstream activity. The subscriber activities may be monitored usage of input devices such as keyboard, mouse or other input devices. Once parameters have been set by the subscriber, the system creates rules which correspond to the parameters and which may be used to compare monitored activities to the set parameters to detect unauthorized activity. During automatic initialization, the subscriber uses the computer system while the system monitors records normal activities. Using the recorded normal activity data, parameters are set and rules created for use detecting activities that deviate from the recorded normal activities.

When an unauthorized activity is detected, the activity may be recorded in an activity log for later use by the system or the subscriber. Alternatively, the rules may include responses to specific detect unauthorized activities such as terminating the activity or notifying the subscriber of the unauthorized use.

### BRIEF DESCRIPTION OF THE DRAWINGS

FIG. 1 illustrates, in block diagram form, a computer system for use with the present method for detection of unauthorized computer system usage;

FIG. 2 illustrates a flow diagram for manually initializing the present method for detection of unauthorized computer system usage;

FIG. 3 illustrates a flow diagram for automatically initializing the present method for detection of unauthorized computer system usage;

FIG. 4 illustrates an operational flow diagram of the present method for detection of unauthorized computer system usage; and

FIG. 5 illustrates a sample activity log for use with the present method for detection of unauthorized computer system usage.

### DETAILED DESCRIPTION

The present method for detection of unauthorized computer system usage summarized above and defined by the enumerated claims may be better understood by referring to the following detailed description, which should be read in conjunction with the accompanying drawings. This detailed description of the preferred embodiment is not intended to limit the enumerated claims, but to serve as a particular example thereof. In addition, the phraseology and terminology employed herein is for the purpose of description, and not of limitation.

Executable applications on the Internet may be downloaded to a subscriber's equipment connected to the Internet for autonomous usage during operation of the equipment without the subscribers authorization, and often, without the subscribers knowledge. The subscriber is often unaware of the installation on the equipment and the possible usage of the application to collect information relating to the subscriber's physical interaction with the equipment. The subscriber is also unaware that the downloaded application may forward the collected information via the subscriber's Internet connection to an unknown and unauthorized party.

The autonomous applications may include peer-to-peer applications such as file sharing techniques, which once loaded by the subscriber must be consciously disabled or uninstalled by the subscriber to prevent autonomous use. When the peer-to-peer application is downloaded without the subscriber's authorization and/or knowledge, the subscriber is not in a position to consciously disable or uninstall the application. Another form of autonomous application uses a distributed computing technique wherein the subscriber's CPU and storage media is autonomously used with the resulting data being transmitted via the subscriber's Internet connection to a central computer. Autonomous usage of a large number of computer CPUs speeds the processing and reduces the equipment required at the central computer, at the expense of the unknowing subscriber. Another application which may be autonomously executed on a subscriber's equipment may collect information on the subscriber's personal use of the equipment or Internet activities and forward the collected information to an entity such as an advertiser.

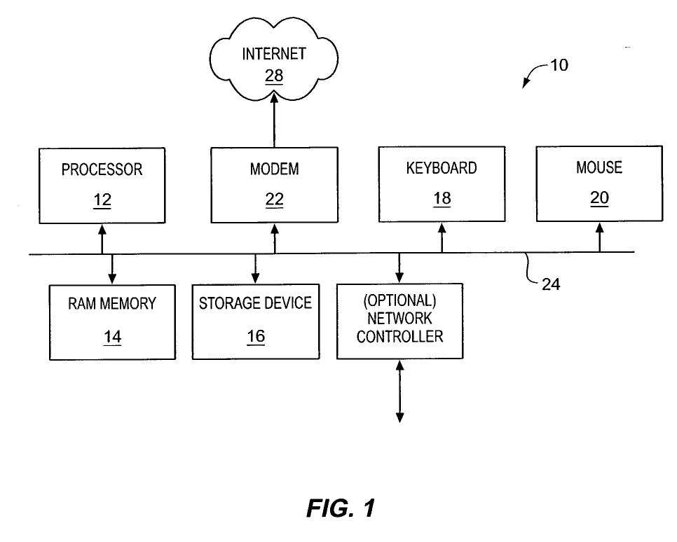

The present method for detection of unauthorized computer system usage monitors the activity of the subscriber during computer system usage. Referring to the block diagram of FIG. 1, the subscriber computer system 10 may include a processing device such as a CPU 12 for executing application software, a random access memory (RAM) 14 for temporary data storage, and one or more storage mediums 16 such as a floppy drive and/or a hard drive. The subscriber computer system may further include one or more input devices such as a keyboard 18 and/or a mouse 20 to allow the subscriber to physically interact with the computer system or the subscriber interaction may be voice activated (not shown). Other input devices may also be attached to the computer equipment, such as a game input device, which may also be monitored. A growing number of computer systems also include a modem 22 or other device allowing the subscriber to access the Internet. The Internet access is provided by an Internet Service Provider (ISP) which provides the subscriber with bandwidth for communication over the Internet.

While the Internet provides the subscriber with the ability to access data from around the world, the Internet connection also provides a connection through which others may autonomously utilize the subscribers computer system, monitor the subscriber's activities to collect information and to forward the information collected to an unknown and/or unauthorized entity. The present method for detecting unauthorized computer system use provides a method to detect, log prevent and/or terminate the autonomous use based on the observed activities of the subscriber and the computer system CPU.

The subscriber's use of input devices to interact with the computer system may be monitored and used to detect unauthorized use. Subscriber activities via input devices such as a keyboard or mouse result in predictable CPU activity. The activities performed by the equipment's CPU may also be monitored. Correlation of the CPU activity, the subscriber's activities and the predictable CPU response to the subscriber activities, provides information that may be used for detecting CPU activity that is inconsistent with the subscriber's interaction with the equipment. Continuous inconsistent CPU activity may be used to detect unauthorized downloading of autonomous applications and/or autonomous usage of the subscriber's equipment. Further monitoring of the subscriber's usage and the Internet activity may reveal additional autonomous usage wherein the unauthorized application is not only utilizing the CPU capacity and the subscriber equipment storage media capacity, but is also using the subscriber's internet bandwidth capacity.

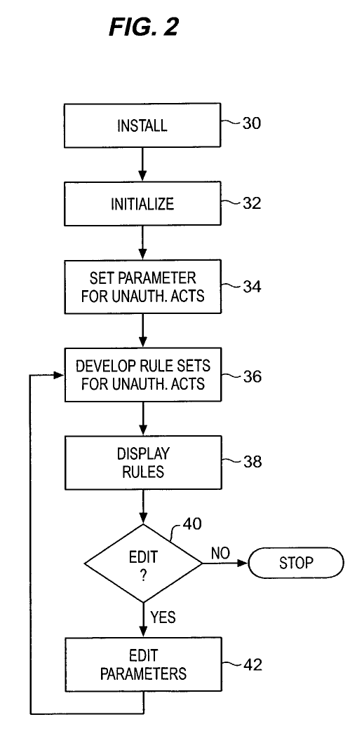

Set-Up Procedures—FIG. 2:

A system embodying the present method for detection of unauthorized computer system usage may be initialized manually or automatically. If manual initialization is selected, the subscriber may set parameters for monitoring for unauthorized usage. Parameters may include time (T), click (C) representing subscriber input via keyboard strokes or mouse clicks, upbytes (U) representing data uploaded to the Internet and downbytes (D) representing data downloaded from the Internet. Time may act as an index for the activity log in which the unauthorized activities are recorded and may be collected at intervals defined by the subscriber during system setup. Allowing the subscriber to select the time intervals during which activities are monitored allows the subscriber to further customize the autonomous usage detection and unauthorized activity detection to meet the subscriber's needs.

The click (C) parameter may be designed to monitor the subscriber's physical interaction with the computer system and may include use of input devices such as keyboard use, mouse or other pointing device use, and gamepad or joystick use. System embodying a voice response system may monitor voice activity as well as, or in place of, manually operating input devices. System performance parameters may include activities such as processor use, RAM access, access of fixed storage devices such as disc drives for reading data from the storage device or writing data to the storage device and application file usage.

The Internet use parameters may include monitoring the output when data is sent upstream to the Internet (U), receipt of data from the Internet (D) and may also include the bandwidth consumption for the upstream and downstream Internet traffic. An activity log may be generated by accumulating and recording the activities for each of the parameters during a monitoring time interval.

Referring to the flow diagram of FIG. 2, first the application software is installed in step 30 on the subscriber's equipment. After installation, the unauthorized usage detection application is initialized in step 31 and the subscriber is prompted to set parameters in step 34 for monitoring the subscribers interaction with the computer system, parameters for monitoring the CPU activity and Internet usage bandwidth corresponding to the Internet usage. Using the parameters set in step 34, an unintentional use prevention software using conventional statistical correlation techniques and/or artificial intelligence rule derivation techniques creates a set of rules in step 36 corresponding to the parameters set in step 34. The set of rules created in step 36 defines the unauthorized system behavior that should be logged for later usage. The subscriber may also select a response to be performed by the computer system when an unauthorized activity is detected.

In step 38 the rules derived in step 36 are displayed for the subscriber's review. If the subscriber determines in step 40 that the parameters should be changed, the parameters are edited in step 42 and new rules are created in step 36 and displayed to the subscriber in step 38 for review. Once the parameters have been set by the subscriber, and rules are created by the unintentional use software, system setup is complete.

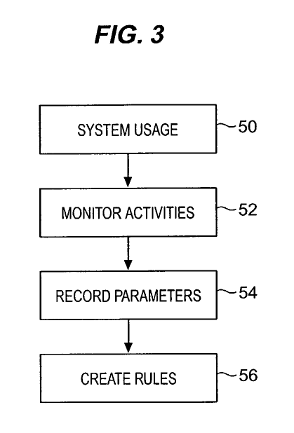

Referring to the flow diagram of FIG. 3, if automatic initialization is selected, the subscriber uses the system in step 50 for an observation time interval. During the observation time interval of step 50, subscriber, system and Internet activities are monitored and recorded in step 52 and 54 respectively. During this observation time interval, parameters such as time (T), clicks (C) representing subscriber input via keyboard strokes or mouse clicks, upbytes (U) representing data uploaded to the Internet and downbytes (D) representing data downloaded from the Internet are monitored. An observation log is created by accumulating all of the activities and parameters monitored during the observation time interval. Using the data recorded in the observation log, the system uses conventional statistical correlation techniques and artificial intelligence rule derivation techniques to create rules in step 56 for detecting unauthorized and/or autonomous activities. Since the unauthorized and/or autonomous activities are activities which deviate from normal system use, monitoring normal computer system usage provides a method for automatically creating rules in step 56 for activities that deviate from the normal system usage observed in step 52. As previously described, the rules may be displayed for the subscriber to review and edit if necessary.

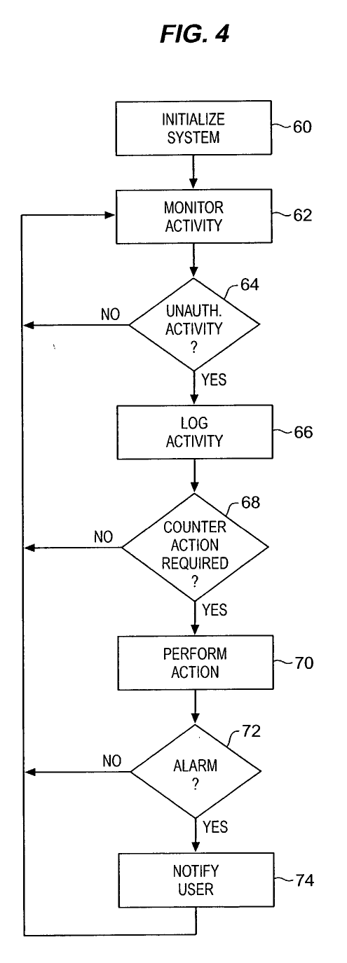

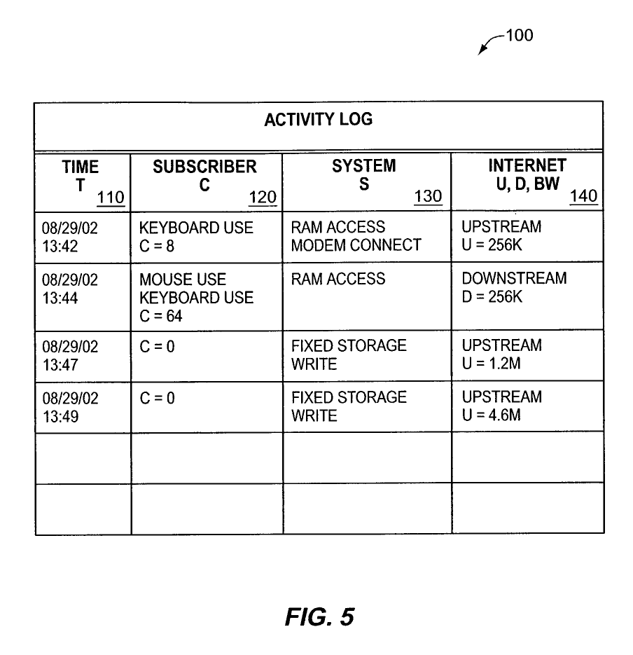

Operationally—FIGS. 4 and 5:

Once the parameters have been set and the corresponding rules developed, the system monitors the subscriber activities, system activities and Internet usage statistics. Referring to the flow diagram of FIG. 4, when the computer equipment is initialized in step 60, the activity of the subscriber, the system activity and the Internet usage is monitored in step 62. When activity is detected in step 62, the activity is analyzed using the rules established in step 36 to determine whether or not the activity is authorized. If the activity is authorized in step 64, the computer system continues to monitor activities in step 62. When an unauthorized activity is detected in step 54, the activity is recorded in an activity log in step 66. If the rule corresponding to the unauthorized activity includes a response, the computer equipment performs the response in step 70 to terminative the unauthorized activity. Alternatively, the response may be an alarm in step 72 wherein the alarm notifies the subscriber in step 74 of the unauthorized activity.

FIG. 5 illustrates a sample activity log 100 in which activities may be recorded. The activities recorded may be a collection of the monitored parameters during the time interval and on an ongoing basis. The subscriber may then use the activity log to manually analyze the activities to better understand the subscriber's system and Internet use patterns. When the system and Internet use patterns are understood, the information may be used to set, or reset, parameters for future monitoring.

To better understand the present method for detecting unauthorized and/or autonomous computer system use, an example of monitored activities and responses to the activities are described in the following paragraph. The system may be configured to monitor subscriber parameters, or clicks C, upstream (U) and downstream (D) activities at scheduled time intervals (T) and recorded the activity in an activity log. The data recorded in the activity log is compared with set constants for each parameter. After monitoring the system for a time interval, the activity log may include the number of bytes sent upstream (upbytes) U and the number of bytes received downstream (downbytes) D during the time interval T and the subscriber's activities, or clicks C, during the same time interval T. The rule used to detect unauthorized or autonomous use may be as follows:

IF [upbytes)>U] OR [(downbytes)>D] AND [clicks<C],

then, SUSPEND all upload and download activity on modem EXCEPT service provider network maintenance

Using the above rule, if the number upbytes recorded is greater than the predefined U or the number of downbytes is greater than the predefined value of D allowable during the time interval and the number of user interactions, clicks, are less than C, then a unauthorized or autonomous activity has been detected. In response to the detection, as indicated from the above rule, the computer system suspends all uploading and downloading activities except maintenance activities performed by the service provider. In other words, if there is Internet activity in the form of uploading or downloading data that is inconsistent with the activities performed by the subscriber, or the subscriber is not actively using the system, then the computer system should suspend the network activity except the network “keep alive” activity.

As to alternative embodiments, those skilled in the art will appreciate that the present method for detection of autonomous computer system usage may be implemented with alternative random variables. While the present method for detecting autonomous usage has been illustrated and described for use within a computer system, the detection software may be installed on an alternative device such as the modem. Likewise, while the parameters have been illustrated and described as time, upbytes, downbytes, and subscriber input activities, alternative parameters may be included for further monitoring system parameters or system activities corresponding to the input activities of the subscriber.

It is apparent that there has been described a method for detection of autonomous computer system usage that fully satisfies the objects, aims, and advantages set forth above. While the method for detection of autonomous computer system usage has been described in conjunction with specific embodiments thereof, it is evident that many alternatives, modifications, and/or variations can be devised by those skilled in the art in light of the foregoing description. Accordingly, this description is intended to embrace all such alternatives, modifications and variations as fall within the spirit and scope of the appended claims.

What is claimed is:

1. A method for detecting autonomous computer system usage comprising:
monitoring an operation of said computer system;
monitoring a subscriber's activity during usage of said computer system;
comparing said monitored computer system operation with said monitored subscriber activity to detect computer system operation that is inconsistent with said monitored subscriber's activity; and
recording said inconsistent computer system activity in a log within said computer system.

2 The method of claim 1 wherein said monitoring of said computer system operation comprises monitoring an Internet connection activity.

3. The method of claim 2 wherein said monitoring of said activity of said computer system further comprises at least one of:
monitoring a memory access;
monitoring a bandwidth usage corresponding to said internet connection activity; and
monitoring a CPU activity.

4. The method of claim 1 wherein said monitoring of said subscriber's activity comprises monitoring a subscriber input device activity

5. The method of claim 1 wherein said comparing comprises:
determining a computer system response to said subscriber activity; and
comparing said computer system response to said operation of said computer system, wherein if said computer system response and said computer system operation do not match, a unauthorized usage has been detected.

6. The method of claim 1 wherein said recording said inconsistent computer system activity comprises recording an Internet activity.

7. The method of claim 6 further comprising recording a bandwidth usage corresponding to said internet activity.

8. The method of claim 6 wherein said recording further comprises:
in a database at least one data of the class of activity data comprising:
a time corresponding to said monitoring;
said subscriber activity; and
said operation of said computer system.

9. The method of claim 1 for further usage to prevent said unauthorized information collection and computer system usage via a broadband Internet connection, further comprising:
performing an action to counter said inconsistent usage to terminate said inconsistent usage.

10. The method of claim 1 further comprising:
notifying said subscriber of said inconsistent computer system activity.

11. A method of preventing autonomous computer system Internet usage comprising:
monitoring an Internet activity;
monitoring a subscriber physical interaction with said computer system;
correlating said monitored Internet activity with said monitored subscriber physical interaction to detect computer system activity that is inconsistent with said monitored subscriber physical interaction; and
recording said inconsistent computer system activity in a log.

12. The method of claim 11 wherein said monitoring further comprises at least one of:
monitoring access to a storage media;
monitoring RAM access; and
monitoring an activity performed by a CPU during said computer system operation.

13. The method of claim 11 wherein monitoring said subscriber physical interaction comprises at least one of:
monitoring a character input device usage;
monitoring a pointing device usage; and
monitoring a game input device usage.

14. The method of claim 11 wherein said correlating said Internet activity and said subscriber physical interaction comprises:
determining a response to said subscriber physical interaction;
correlating said response to said Internet activity, wherein if said Internet activity is inconsistent with said subscriber physical interaction response said Internet activity is an autonomous activity.

15. The method of claim 11 wherein said monitoring of said Internet activity said monitoring of said subscriber physical interaction is performed periodically.

16. The method of claim 15 wherein said periodic performance is at scheduled intervals.

17. The method of claim 11 further comprising:
monitoring a bandwidth corresponding to said Internet activity.

18. The method of claim 17 wherein said periodic performance is contingent on usage of said broadband Internet connection.

19. The method of claim 11 further comprising:
manually setting a parameter corresponding to said Internet activity and said subscriber physical interaction for use correlating said Internet activity with said subscriber physical interaction to detect said inconsistent computer system activity.

20. The method of claim 19 wherein said parameter includes at least one of:
a time corresponding to said monitoring;
said subscriber physical interaction with said computer system; and
a data size corresponding to a transmission of data during said internet usage.

21. The method of claim 11 further comprising:
automatically setting a parameter corresponding to said Internet activity and said subscriber physical interaction for use correlating said Internet activity with said subscriber physical interaction to detect said inconsistent computer system activity.

22. The method of claim 21 wherein said automatically setting said parameter comprise at least one of:
monitoring said subscriber physical interaction with said computer system for a time period;
monitoring said internet activity;
setting said parameters in accordance with said monitored subscriber physical interaction with said computer system and said Internet activity.

23. The method of claim 22 wherein said parameter includes at least one of:
a time corresponding to said monitoring;
said subscriber physical interaction with said computer system;
a bandwidth corresponding to said Internet usage; and
a data size corresponding to a transmission of data during said internet usage.
